(19) United States
(12) Patent Application Publication
(10) Pub. No.: US 2025/0010701 A1
(43) Pub. Date: Jan. 9, 2025

(54) WHEEL MOTOR UNIT

(71) Applicant: AISIN CORPORATION, Kariya (JP)

(72) Inventors: Masakazu OHASHI, Kariya-shi (JP); Nobuyuki Nagasaka, Kariya-shi (JP); Yuki Okabe, Kariya-shi (JP); Shigefumi Mori, Kariya-shi (JP); Noriaki Nonaka, Kariya-shi (JP)

(73) Assignee: AISIN CORPORATION, Kariya (JP)

(21) Appl. No.: 18/750,343

(22) Filed: Jun. 21, 2024

(30) Foreign Application Priority Data
Jul. 7, 2023 (JP) 2023-112210

(51) Int. Cl. B60K 7/00; B60K 17/04; B62D 5/04

(52) U.S. Cl. CPC B60K 7/0007; B60K 17/043; B62D 5/0418

(57) ABSTRACT

A wheel motor unit includes: a housing to which an axle supporting a vehicle wheel of a vehicle is attached, the housing being supported by a vehicle body; and a plurality of motors attached to the housing. Each of the motors has either a steering function of changing a posture of the axle, a driving function of rotating the axle, or a braking function of restricting rotation of the axle, and extending directions of rotation shafts of the motors are parallel to each other.

### CROSS REFERENCE TO RELATED APPLICATIONS

This application is based on and claims priority under 35 U.S.C. § 119 to Japanese Patent Application 2023-112210, filed on Jul. 7, 2023, the entire content of which is incorporated herein by reference.

### TECHNICAL FIELD

This disclosure relates to a wheel motor unit including a housing that includes an axle and is supported by a vehicle body, and the housing is provided with a plurality of motors that individually perform a steering function, a driving function, or a braking function for axle.

### BACKGROUND DISCUSSION

In the related art, such a wheel motor unit is disclosed in, for example, WO2021/044469A1 (see [0010] to [0011] and FIG. 1).

In this steering module 10, a steering shaft portion 12 is fixed to a fixed support portion 14 provided on a vehicle body, and a swing body 18 is supported by the steering shaft portion 12 in a manner of being swingable in steering. A vehicle wheel support portion 20 is externally mounted on the swing body 18 and rotatably supports a vehicle wheel 110. The swing body 18 can be freely steered with respect to the steering shaft portion 12 by driving a steering motor unit 22. In the related art, in particular, the steering motor unit 22 applies a torque to the steering shaft portion 12 so that the vehicle wheel 110 can be maintained in a straight traveling state.

According to this technique, a degree of freedom in designing the steering module 10 can be improved. For example, when a position of the steering shaft portion 12 of the steering module 10 is changed, a scrub radius increases. As a result, the torque around the steering shaft portion 12 is generated when the vehicle is traveling, and a direction of the vehicle wheel becomes unstable.

Therefore, in the related art, the steering motor unit applies, to the steering shaft portion 12, a torque that maintains the vehicle wheel in the straight traveling state. This increases steering stability of the vehicle wheel. Therefore, necessity of reducing the scrub radius decreases, and the degree of freedom in designing the steering module 10 increases, such as by widening an allowable range of an installation position of the steering shaft portion 12.

In the related-art steering module 10, the steering motor unit 22 of the vehicle wheel is disposed inside the vehicle wheel 110, thereby saving space. However, since the steering shaft portion 12 is disposed in a state of protruding to a lateral side of the vehicle wheel 110, it is essential to apply the torque to the steering shaft portion 12 in order to maintain the steering stability of the vehicle wheel. Therefore, a torque generation mechanism for this purpose is essential, and a configuration of the steering module 10 is complicated and enlarged.

Since the steering shaft portion 12, that is, a kingpin, is deviated to a lateral side of a tire, when steering the vehicle wheel, a predetermined steering resistance is generated according to a distance from an intersection of an extension line of the kingpin and a road surface to a ground contact position of the vehicle wheel. Therefore, durability of the steering module 10 may be impaired, for example, wear of parts constituting the steering module 10 progresses and rattling occurs.

A need thus exists for a wheel motor unit which is not susceptible to the drawback mentioned above.

### SUMMARY

According to an aspect of this disclosure, there is provided a wheel motor unit including:
a housing to which an axle supporting a vehicle wheel of a vehicle is attached, the housing being supported by a vehicle body; and
a plurality of motors attached to the housing, in which
each of the motors has either a steering function of changing a posture of the axle, a driving function of rotating the axle, or a braking function of restricting rotation of the axle, and extending directions of rotation shafts of the motors are parallel to each other.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an external view of a vehicle using a wheel motor unit according to a first embodiment;

FIGS. 2A and 2B are front views showing a configuration of the wheel motor unit;

FIG. 3 is a cross-sectional view showing a configuration of a drive unit provided in the wheel motor unit;

FIG. 4 is a cross-sectional view showing a configuration of a braking unit provided in the wheel motor unit;

FIG. 5 is a cross-sectional view showing a configuration of a steering unit provided in the wheel motor unit;

FIG. 6 is a cross-sectional view showing a configuration example of a housing of the wheel motor unit;

FIG. 7 is a view showing a configuration example of the wheel motor unit;

FIG. 8 is a cross-sectional view showing a configuration example of a wheel motor unit according to a second embodiment; and

FIG. 9 is a view showing a configuration example of a wheel motor unit according to a third embodiment.

### DETAILED DESCRIPTION

### First Embodiment

### Overview

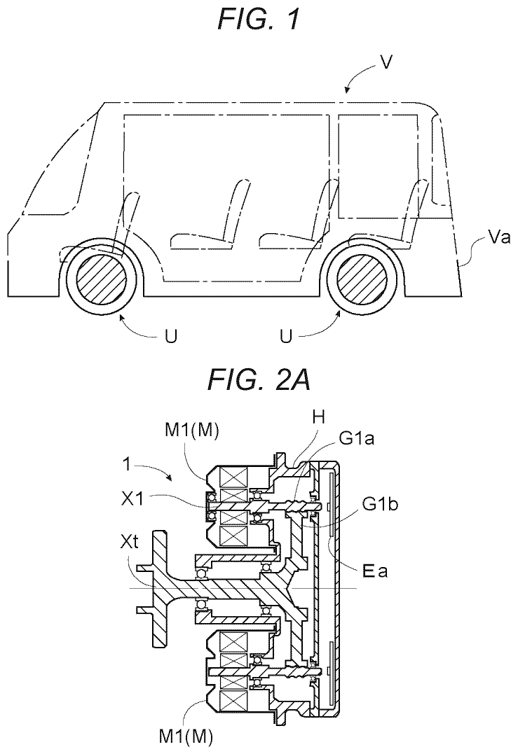

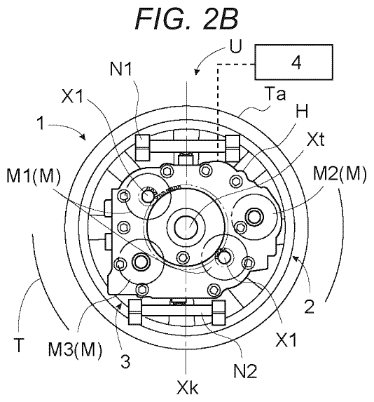

A wheel motor unit U (hereinafter, simply referred to as a “unit U”) disclosed here is used, for example, in a vehicle V such as a small electric low-speed travelling vehicle as shown in FIG. 1, and is implemented such that drive motors M1, a braking motor M2, and the like of the vehicle V are arranged inside a wheel Ta of a vehicle wheel T as shown in FIG. 2. Accordingly, each vehicle wheel T is rotationally driven and braked, and the vehicle wheel T is also steered. Using the wheel motor unit U disclosed here, it is possible to independently control four wheels, and to attain various traveling states such as oblique traveling, turning with a fairly small radius, and even spin turning in addition to normal straight-line traveling and turning traveling. In addition, it is possible to ensure a large cargo space in a vehicle body Va, improve transport capacity, and also perform automatic driving with various traveling routes set. Hereinafter, a first embodiment of the wheel motor unit U will be described with reference to FIGS. 1 to 7.

As shown in FIGS. 2A and 2B, the unit U disclosed here includes a housing H interposed between the vehicle body Va and the vehicle wheel T, and an axle Xt that supports the vehicle wheel T is attached to a center of the housing H. The unit U has a plurality of functions, such as a steering function of changing a posture of the axle Xt, a driving function of rotating the axle Xt, and a braking function of restricting rotation of the axle Xt. In order to implement these functions, a motor M corresponding to each purpose is attached to the housing H.

FIGS. 2A and 2B show an example in which four motors M are provided. Specifically, two drive motors M1 that drive the vehicle wheel T, the braking motor M2, and a steering motor M3 are provided. These will be described in detail later.

The housing H is provided with an upper knuckle N1 and a lower knuckle N2 that support the housing H on the vehicle body Va. As shown in FIG. 2B, the upper knuckle N1 and the lower knuckle N2 are formed in dimensions that fit within an inner diameter of the wheel Ta. According to this configuration, the unit U is fairly compact, and a degree of freedom in designing a support structure for the vehicle wheel T is greatly increased. For example, a steering shaft Xk formed across the upper knuckle N1 and the lower knuckle N2, that is, a kingpin, is provided at a position penetrating through the housing H. Therefore, when the vehicle wheel T is viewed from a front side, an intersection of an extension line of the kingpin and a road surface coincides with a ground contact region of the vehicle wheel T.

Therefore, a scrub radius is small, and no unnecessary resistance occurs during steering. Therefore, the steering motor M can be more compact, and the rational unit U can be obtained. If the unit U has a dimension that fits within the inner diameter of the wheel Ta, a large loading space or the like for the vehicle body Va can be ensured, various auxiliary devices can be easily mounted on the vehicle body Va, and a degree of effective utilization of the vehicle V increases, for example, a living space for people widens.

### Drive Unit

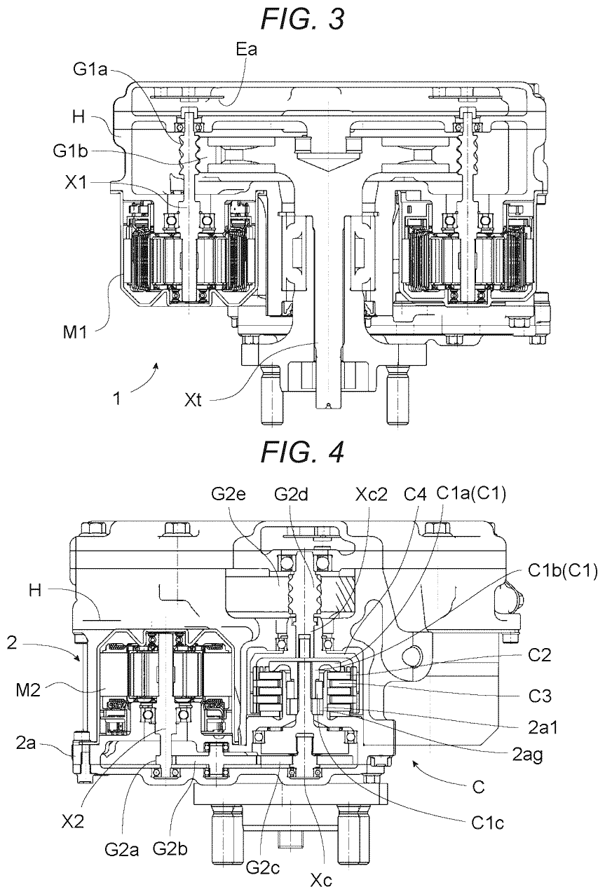

FIG. 3 shows a cross-sectional configuration of a drive unit 1 having a driving function in the present embodiment. The drive unit 1 includes two drive motors M1 located symmetrically about the axle Xt. The drive unit 1 also includes a gear train that transmits a rotational driving force from the drive motor M1 to the vehicle wheel. Since the two drive motors M1 and the gear train have the same configuration, one drive motor M1 and the like will be described.

The drive motor M1 is attached to the housing H from the outside of the vehicle V in a posture in which a drive output shaft X1 thereof is parallel to the axle Xt. Therefore, when attaching the drive motor M1 to and detaching the drive motor M1 from the housing H, the wheel Ta is removed.

Various motors M can be used as the drive motor M1. However, an encoder or the like is preferably mounted to calculate a rotation speed of the vehicle wheel T. The drive motor M1 is attached to the housing H with bolts or the like. A drive helical gear G1a having a small number of teeth is attached to a tip end of a drive output shaft X1, and meshes with a large-diameter drive driven gear G1b provided to rotate integrally with the axle Xt. Using the helical gear, a meshing ratio between the gears is improved and rotation is smoothly transmitted.

Further, the drive driven gear G1b is driven by the drive output shafts X1 at two positions symmetrical about the axle Xt, preventing eccentricity and rattling of the drive driven gear G1b, and ensuring smooth driving rotation accordingly.

These drive motors M1 are driven and controlled by signals from a control unit 4 (not shown). As shown in FIG. 3, an ECU board Ea of the drive motor M1 is provided at a position opposite to the drive motor M1 across the drive helical gear G1a. Here, an IC chip or the like for obtaining rotation information on the drive output shaft X1 is also mounted.

### Braking Unit

FIG. 4 shows a cross-sectional configuration of a braking unit 2 having a braking function in the present embodiment. The braking unit 2 includes the braking motor M2 and a clutch C. As shown in FIG. 4, both are formed in a braking case 2a as one assembly and attached to the housing H. In the braking case 2a, the braking motor M2 and the clutch C are arranged in parallel, and rotational driving of the braking motor M2 is transmitted to the clutch C via a spur gear.

The braking motor M2 is operated and controlled by, for example, the control unit 4, and is rotationally driven when braking the vehicle wheel T. A small-diameter first spur gear G2a is provided on a braking output shaft X2, and rotation thereof is transmitted to a clutch gear G2c of the clutch C via a first intermediate gear G2b. Rotation of the clutch gear G2c is further transmitted to a clutch shaft Xc. A clutch pressing plate C1 is screwed onto the clutch shaft Xc. The clutch pressing plate C1 includes a cylindrical portion C1b screwed onto the clutch shaft Xc, and a disk-shaped pressing portion C1a provided at an end portion of the cylindrical portion C1b.

An outer circumferential surface of the cylindrical portion C1b is surrounded by a cylindrical receiving portion 2a1 protruding from a portion of the braking case 2a. At least one protruding guide 2ag is formed on an inner surface of the receiving portion 2a1 in parallel to an extending direction of the clutch shaft Xc, and a groove C1c engaged with the protruding guide 2ag to thrust-move the clutch pressing plate C1 is formed on the outer circumferential surface of the cylindrical portion C1b. That is, the clutch pressing plate C1 is thrust-moved by rotating the clutch shaft Xc by the braking motor M2.

For example, three first clutch plates C2 that are non-rotatable with respect to the receiving portion 2a1 and that are movable in parallel along a protruding direction of the receiving portion 2a1 are formed on an outer circumferential surface of the receiving portion 2a1 provided in the braking case 2a. A second clutch plate C3 is interposed between the first clutch plates C2. The second clutch plate C3 is provided on an inner surface of a braking drum C4 that rotates coaxially with the clutch shaft Xc in a manner of being non-rotatable relative to the braking drum C4 and being movable along a rotation axis of the braking drum C4. A braking drum shaft Xc2 is connected to one end portion of the braking drum C4 by serration fitting, and a first braking gear G2d formed of a helical gear is provided on the braking drum shaft Xc2. On the other hand, a second braking gear G2e with which the first braking gear G2d meshes is provided on an outer surface of the axle Xt.

That is, when the axle Xt rotates, the braking drum C4 is driven to rotate via the second braking gear G2e and the first braking gear G2d. In contrast, when the braking motor M2 is in a non-operating state, the clutch pressing plate C1 is not operated, and no frictional force is generated between the first clutch plate C2 and the second clutch plate C3. On the other hand, when the braking motor M2 is driven, the first clutch plate C2 is pressed against the second clutch plate C3, a frictional force increases, and the axle Xt is braked via the braking drum C4.

### Steering Unit

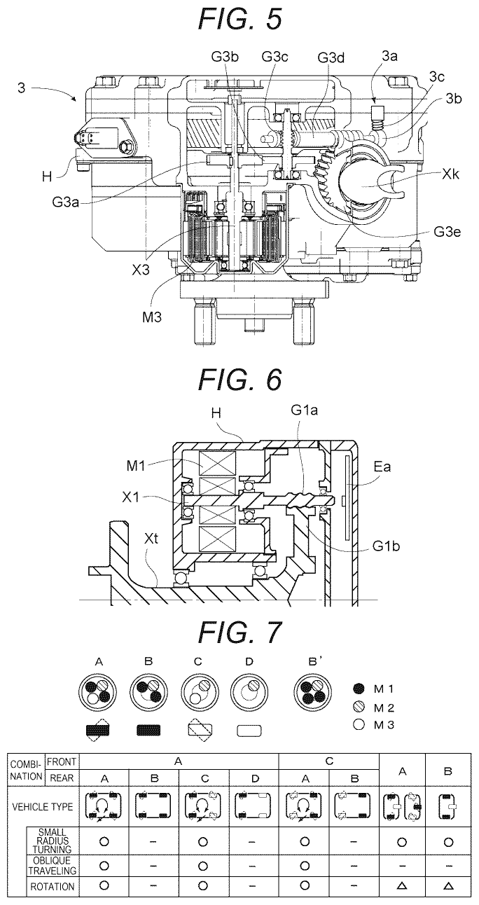

FIG. 5 shows a cross-sectional configuration of a steering unit 3 having a steering function in the present embodiment. The steering unit 3 includes the steering motor M3 and a gear train extending from the steering motor M3 to the steering shaft Xk provided in the housing H.

Specifically, a first steering gear G3a is provided at an end portion of a steering output shaft X3 of the steering motor M3, and meshes with a first steering intermediate gear G3b provided in the housing H. A first steering helical gear G3c having a small number of teeth is provided on a shaft of the first steering intermediate gear G3b. Further, a rod-shaped second steering intermediate gear G3d meshes with the first steering helical gear G3c, and the other end portion of the second steering intermediate gear G3d meshes with a steering gear G3e mounted on the steering shaft Xk.

The steering motor M3 does not rotate and remains stationary while the vehicle V continues straight-line traveling or turning traveling. On the other hand, when shifting to another steering state, the steering motor M3 rotates by a predetermined angle based on a control signal from the control unit 4. Therefore, the steering motor M3 preferably includes an encoder or the like to detect a rotation angle.

When the steering gear G3e is driven, the second steering intermediate gear G3d tends to move away from the steering gear G3e due to a contact reaction force between the gears. Backlash may originally be present between the gears. In this case, when a steering rotation direction is reversed, a non-operating state occurs, making a steering operation unstable and deteriorating a steering feeling. Further, the vehicle wheel wobbles by an amount of the backlash in response to input from the vehicle wheel. In order to prevent this, a biasing portion 3a is preferably provided at a position adjacent to the second steering intermediate gear G3d.

Necessity of such biasing between the gears is related to attaching the drive motors M1, the braking motor M2, and the like to the housing H in the same direction. Holding positions of the drive output shaft X1 and the like depends on a processing position of a bearing portion provided on a wall portion of the housing H. If a processing error occurs, a state of meshing between the gears is not necessarily optimal. Therefore, the biasing portion 3a is provided to press the second steering intermediate gear G3d against the steering gear G3e.

Specifically, a bearing 3b that rotatably supports an end portion of the second steering intermediate gear G3d is biased in a direction perpendicular to an axis of the second steering intermediate gear G3d and toward the steering gear G3e. Therefore, a coil spring 3c having a predetermined spring constant is preferably provided in a part of the housing H. In this way, if the second steering intermediate gear G3d is a worm, a distance between a meshing position with the steering gear G3e and a position of the spring biasing is easily ensured, and an effect of holding the meshing state is improved.

By providing the biasing portion 3a as in this configuration, no rattling occurs during driving transmission between the gear trains, allowing smooth and quiet driving. As a result of preventing rattling, a state of the gears being contact with each other is appropriately maintained, and problems such as uneven wear of the gears and poor durability are prevented.

As shown in FIG. 2, in the present embodiment, output shafts of all the motors M including the drive motors M1, the braking motor M2, and the steering motor M3 are parallel to each other and parallel to the axle Xt.

If extending directions of rotation shafts of all the motors M are parallel, a configuration of a mechanism connected to the output shaft of each motor M can be rationally set. For example, if axial directions of the individual motors M are parallel, each auxiliary device can be disposed in a space on the same side of the motors M.

In many cases, various gear trains mesh with the motors M, and if the output shafts are parallel, interference between the gear trains attached thereto can be easily avoided. For example, since the various gears that mesh with the output shafts of the motors M are often aligned along a direction of the output shafts, attachment positions of the gears can be adjusted along the axial directions. Therefore, according to this configuration, assembly work and maintenance work of the unit U are efficient.

### Configuration of Housing

As shown in FIG. 6, the housing H according to the present embodiment may have a box-shaped integral structure. Such a housing H can be formed by, for example, injection molding using aluminum, cutting from a block material, or casting using iron.

Accordingly, even if a wall thickness of the housing H is set to be small, overall rigidity can be maintained high. Positioning and fixing work of each motor M is facilitated, and efficiency of the assembly work can be improved. A dustproof effect can also be improved by covering many portions of the unit U.

Although not shown in the drawings, in addition to having the integral structure as a whole, the housing H may also be formed of a housing body having an entire outer peripheral wall, and a planar front cover and a planar back cover, which are orthogonal to the axle Xt so as to close the housing body. The front cover and the back cover are fixed to the housing body using bolts or the like. According to this configuration, components such as the motors M and gears can be attached and detached from two directions along the axle Xt, improving workability.

### Functional Variations of Wheel Motor Unit

By using the unit U having the above configuration, for example, the vehicle V having variations shown in FIG. 7 can be implemented. That is, various types of units U can be applied as front wheels and rear wheels of the four-wheeled vehicle V.

For example, if both the front and rear wheels are implemented by the units U each including all of the drive motors M1, the braking motor M2, and the steering motor M3 (a combination A+A in FIG. 7), the vehicle wheel T supported by the unit U can perform oblique traveling and spin turning in addition to small radius turning. In this case, for example, the vehicle can be used as a factory transport vehicle or for mobility in a commercial facility.

As shown in a combination A+B in FIG. 7, when the front wheel includes the three types of motors M described above and the rear wheel includes only the drive motors M1 and the braking motor M2, the vehicle is a general four-wheeled drive vehicle.

As shown in a combination A+C in FIG. 7, if the rear wheel does not include the drive motor M1 but includes the braking motor M2 and the steering motor M3, the same traveling as the vehicle V having a configuration in paragraph is possible.

Further, as shown in a combination A+D in FIG. 7, the rear wheel may include only the braking motor M2. According to this configuration, for example, the vehicle V having a simple configuration, such as a factory transport vehicle, can be obtained.

Further, a general rear wheel drive vehicle can also be obtained in which the front wheel includes the braking motor M2 and the steering motor M3 and the rear wheel includes all the motors M (a combination C+A in FIG. 7), or the rear wheel includes the drive motors M1 and the braking motor M2 (a combination C+B in FIG. 7).

Alternatively, as shown in combinations A and B in FIG. 7, the three-wheeled vehicle V can be implemented. According to this configuration, the fairly small vehicle V having a small turning radius can be implemented. Since the three-wheeled vehicle V has a small vehicle body dimension, using the unit U according to the present embodiment, an effect of enlarging an in-vehicle space is remarkable.

### Second Embodiment

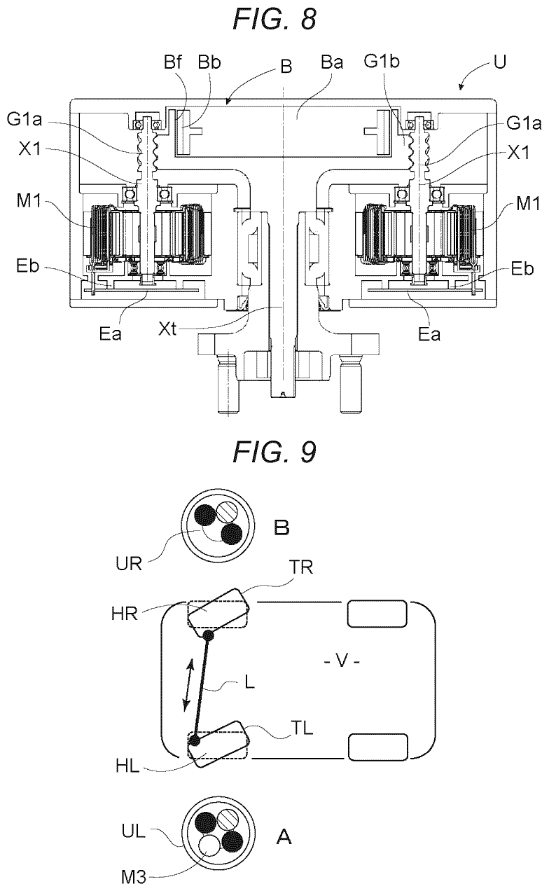

In the unit U shown in FIG. 8, the braking motor M2 is omitted. The drive motors M1 are visible on both left and right sides, and the steering motor M3 is located at a position different from the cross section. In this example, a drum brake B is provided at a central portion of the drive driven gear G1b provided on one side of the axles Xt.

A recess Ba is formed on a back side of the drive driven gear G1b, and an inner circumferential surface thereof is defined as a contact surface Bf of a braking shoe Bb. The braking shoe Bb can be driven in various ways, such as by an operation by an occupant or by a braking mechanism (not shown). According to this configuration, a meshing position of the drive helical gear G1a and the drive driven gear G1b and a position of the contact surface Bf have a substantially front and back relationship. Therefore, a flow dimension of the drive driven gear G1b along an extending direction of the axle Xt is reduced, thereby saving space.

In a case of this configuration, the ECU board Ea of the drive motor M1 is provided in the vehicle V on an outer side with respect to the drive motor M1. Accordingly, a distance from the drive motor M1 to a bus bar Eb is small, and wiring connection work becomes easy. Further, by providing a rotation sensor or the like on the ECU board Ea, twisting of the drive output shaft X1 is less likely to occur than when the rotation sensor is disposed further beyond the drive helical gear G1a. Therefore, accuracy of identifying a rotational phase of the drive output shaft X1 is improved.

### Third Embodiment

When the unit U disclosed here is used for the four-wheeled vehicle V, it is not necessary to dispose the unit U having the same configuration on the left and right vehicle wheels T. For example, in an example shown in FIG. 9, the steering motor M3 may be provided only in a left unit UL disposed on a left vehicle wheel TL, and a steering link L may be provided across a left housing HL and a right housing HR.

In a case of this configuration, it is necessary to transmit a driving force of the steering motor M3 provided on one left vehicle wheel TL to the other right vehicle wheel TR, and to have factors such as whether the driving force of the steering motor M3 is relatively strong or whether a steering resistance of the vehicle wheel T against a road surface is small. However, if these conditions are satisfied, a total number of the steering motors M3 can be reduced, and a device configuration of the entire vehicle V can be more rationalized.

### INDUSTRIAL APPLICABILITY

The wheel motor unit disclosed here can be widely used in vehicles that drive and brake each individual vehicle wheel.

### Features

According to an aspect of this disclosure, there is provided a wheel motor unit including:
a housing to which an axle supporting a vehicle wheel of a vehicle is attached, the housing being supported by a vehicle body; and
a plurality of motors attached to the housing, in which
each of the motors has either a steering function of changing a posture of the axle, a driving function of rotating the axle, or a braking function of restricting rotation of the axle, and extending directions of rotation shafts of the motors are parallel to each other.

### Effects

As in this configuration, if the directions of the rotation shafts of all the motors are parallel, a configuration of a mechanism connected to a drive shaft of the motor can be rationally set. For example, when individual motors are used as separate functional components, if axial directions are parallel, each auxiliary device can be disposed in a space on the same side of the motors. As a result, auxiliary devices are less likely to interfere with each other, and a device configuration becomes easy.

For example, when a plurality of motors are desired to cooperate with each other for driving, if the axial directions thereof are parallel, a configuration of a rotation force extraction mechanism is simplified.

Further, a mounting direction of a motor body or an attachment direction of various gears or the like to the drive shaft of the motor is often along a direction of the drive shaft. Therefore, according to this configuration, assembly work and maintenance work of the wheel motor unit are efficient.

### Features

In the wheel motor unit disclosed here, the entire housing can fit within an inner diameter of a wheel of the vehicle wheel.

### Effects

According to this configuration, the wheel motor unit is fairly compact, and a degree of freedom in designing a support structure for the vehicle wheel is greatly increased. As a result, more space can be ensured on a vehicle body side, various auxiliary devices can be easily mounted on the vehicle body, and a degree of effective utilization of the vehicle increases, for example, a living space for people widens.

Further, in particular, since the entire housing including the motor having the steering function fits within the inner diameter of the wheel, an intersection of an extension line of a steering shaft and the ground can be brought close to a ground contact point of the vehicle wheel with the ground. That is, a scrub radius is small, and no unnecessary resistance occurs during steering. Therefore, a more rational wheel motor unit can be obtained, such as a more compact configuration of a steering motor.

### Features

In the wheel motor unit disclosed here, a gear train that transmits driving rotation of an output shaft of the motor can be provided in the housing, and one of gears that mesh with each other can be provided with a biasing portion that presses the one of gears toward the other gear.

### Effects

The motor having this configuration is attached to the housing in the same direction and that direction is parallel to a direction in which the output shaft extends. Therefore, holding a position of each output shaft depends on a processing position of a bearing portion provided on a wall portion of the housing. In this case, when a processing error occurs, a state of meshing between the gears is not necessarily optimal. Therefore, in this configuration, the one of gears is movable in a direction perpendicular to the axial direction, and the biasing portion that presses the one of gears toward the other gear is provided.

By providing the biasing portion as in this configuration, no rattling occurs during driving transmission between the gear trains, allowing smooth and quiet driving. As a result of preventing rattling, a state of the gears being contact with each other is appropriately maintained, and problems such as uneven wear of the gears and poor durability are prevented.

### Features

In the wheel motor unit disclosed here, it is preferable that a link is provided across a left housing provided on a left vehicle wheel as the housing and a right housing provided on a right vehicle wheel as the housing, and the motor provided in the left housing or the right housing and having the steering function, the driving function, or the braking function implements the steering function, the driving function, or the braking function related to the other vehicle wheel.

### Effects

According to this configuration, one motor provided on either the left or right vehicle wheel can operate the opposite vehicle wheel via the link. Therefore, the number of motors mounted on the entire vehicle can be reduced, and the device configuration can be more rationalized.

For example, using a margin generated at a mounting position of the motor in a simplified manner, a motor having a driving function can be added to one of left and right sides and various functions of the entire vehicle can be strengthened.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A wheel motor unit comprising:
a housing to which an axle supporting a vehicle wheel of a vehicle is attached, the housing being supported by a vehicle body; and
a plurality of motors attached to the housing, wherein
each of the motors has either a steering function of changing a posture of the axle, a driving function of rotating the axle, or a braking function of restricting rotation of the axle, and
extending directions of rotation shafts of the motors are parallel to each other.

2. The wheel motor unit according to claim 1, wherein
the entire housing fits within an inner diameter of a wheel of the vehicle wheel.

3. The wheel motor unit according to claim 1, wherein
a gear train that transmits driving rotation of an output shaft of the motor is provided in the housing, and one of gears that mesh with each other is provided with a biasing portion that presses the one of gears toward the other gear.

4. The wheel motor unit according to claim 1, wherein
a link is provided across a left housing provided on a left vehicle wheel as the housing and a right housing provided on a right vehicle wheel as the housing, and the motor provided in the left housing or the right housing and having the steering function, the driving function, or the braking function implements the steering function, the driving function, or the braking function related to the other vehicle wheel.

5. The wheel motor unit according to claim 2, wherein
a link is provided across a left housing provided on a left vehicle wheel as the housing and a right housing provided on a right vehicle wheel as the housing, and the motor provided in the left housing or the right housing and having the steering function, the driving function, or the braking function implements the steering function, the driving function, or the braking function related to the other vehicle wheel.

6. The wheel motor unit according to claim 3, wherein
a link is provided across a left housing provided on a left vehicle wheel as the housing and a right housing provided on a right vehicle wheel as the housing, and the motor provided in the left housing or the right housing and having the steering function, the driving function, or the braking function implements the steering function, the driving function, or the braking function related to the other vehicle wheel.
